(19) United States
(12) Patent Application Publication
(10) Pub. No.: US 2021/0285281 A1
(43) Pub. Date: Sep. 16, 2021

(54) Systems and Methods for a Roll-Up Door

(71) Applicant: ASI Doors, Inc., Milwaukee, WI (US)

(72) Inventor: Scott E. Booker, Oconomowoc, WI (US)

(21) Appl. No.: 17/200,542

(22) Filed: Mar. 12, 2021

Related U.S. Application Data
(60) Provisional application No. 62/989,073, filed on Mar. 13, 2020.

(51) Int. Cl. E06B 9/15

(52) U.S. Cl. CPC E06B 9/15; E06B 2009/1566; E05Y 2900/132

(57) ABSTRACT

A roll-up door assembly includes a header, a face frame, and a lift frame. The lift frame is removably coupled to the header and is configured to be conveniently discarded once the header is securely installed to the face frame. The header further includes links along at least one end of individual slats that comprise a door panel. The links and the slats are configured to be rolled and unrolled from a spiral as the door panel is opened and closed. The links include a noise abatement feature that is adapted to decrease a sound pressure level associated with the links impacting, for instance, one another during the process opening and closing the door. The links further include a friction reduction surface that reduces friction at the coupling of adjacent links.

### CROSS-REFERENCE TO RELATED APPLICATION

This application claims priority under 35 U.S.C. § 119 to U.S. Provisional Patent Application No. 62/989,073 filed on Mar. 13, 2020, the disclosure of which is hereby incorporated by reference for all purposes.

### STATEMENT CONCERNING FEDERALLY SPONSORED RESEARCH AND DEVELOPMENT

Not applicable.

### TECHNICAL FIELD

The present disclosure is generally related to a roll-up door with slats that are rolled up into a coil of several layers or paid out to provide the slats generally in a plane as a closure over an opening.

### BACKGROUND

Roll-up doors can include a door panel that comprises a series of adjacent slats. The slats are rolled onto a reel assembly to create a drum or barrel assembly, which is housed within a header of the roll-up door. In such roll-up doors, individual links are connected to the lateral ends of the slats (e.g., via endcaps), and the links along each side edge of the door panel are hingedly coupled to one another. The links are coiled to stack on top of one another when the door panel is rolled up and can be configured to prevent the slats from contacting each other. In general, the roll-up door is configured such that the door panel, at the point at which it departs from the reel near the header, maintains a substantially coplanar entry and exit orientation with side guides along the door face frame (e.g., legs/jambs) as the door closes and opens. The controlled entry and exit dynamics generally reduce friction, increase speed, diminish noise, and facilitate self-alignment of each slat of the door panel.

During a typical installation process of a roll-up door assembly, the roll-up door generally requires use of a lift truck to assist with the installation of the header above the doorway or opening that will be selectively covered by the door panel. As such, a frame is often secured to the header when shipped from a manufacturer. The frame provides a support structure for the lift truck to engage without damaging the roll-up door panel assembly. Oftentimes the frame is removed from the header following the securement of the roll-up door assembly to the wall. As a result, the frame must be removed and disposed of at the jobsite, which can be costly and burdensome, especially when the frame is of a metallic construction.

In addition to certain challenges faced during installation of a roll-up door assembly, other issues arise during operation of the roll-up door. For example, while the controlled entry and exit of the door panel generally reduces noise from excessive contact between the door panel and certain structures of the door assembly, such as the side guides, there remains a relatively high sound pressure level caused by the links secured to the individual door slats. In particular, while the door panel is opening at high speeds, the links, which are often constructed from plastic, are being quickly coiled into contact with adjacent links, resulting in an undesirably high sound pressure level. Furthermore, the cyclical high-speed winding and unwinding of the plastic links from the barrel assembly imparts an angular loading on the hinged coupling between links. As a result, fatigue and wear between links can be exacerbated at the coupling (e.g., pin bores) and require additional maintenance to inhibit premature repair and/or replacement of the links.

Therefore, in view of at least the above, a need exists for a roll-up door assembly having improved link sound abatement and link wear management, as well as enhanced support frame implementation for the installation and use of the roll-up door assembly.

### SUMMARY

Some embodiments described herein provide a door assembly that includes a header, a face frame, and a lift frame. The header can be configured as a roll-up door with a door panel including slats on a reel. The face frame can be configured as side guides that can be positioned adjacent to the sides of a doorway and configured to guide the door panel when the door panel is moved between an opened and a closed position. The lift frame is removably coupled to the header and is configured as a support structure that a lift truck, or the like, may interface with during installation of the header. The lift frame can be decoupled from the header and discarded after the header is secured to the face frame.

In some embodiments, the lift frame is a renewable and/or a recyclable material. In some embodiments, the lift frame incorporates one or more wooden supports. The wooden supports can comprises one or more wood truss sections, such as pre-engineered first and second I-beams. The wooden truss may further include a plurality of crossbeams that engage each of the first and second I-beams. The crossbeams may be wooden and configured to be removably coupled with the header at a plurality of locations along the header. Furthermore, the wooden truss may include wooden support beam assemblies configured to be engaged by a lift truck.

Some embodiments described herein provide a roll-up door assembly with a door panel including slats engaged with a reel that can be rotated in one direction so as to roll up the slats into a coil of several layers on the reel, or rotated in an opposite direction so as to pay out the slats from the coil generally in a closure plane adjacent a doorway. The slats includes links coupled to each end of the slat, such as via endcaps. The links along respective edges of the slats are hingedly coupled to one another, and are configured to stack on top of one another (e.g., nest) when the door panel is rolled up, thus inhibiting adjacent slats from contacting each other.

In other embodiments, the links have cooperating structures on inner sides and outer surfaces so that the links guide and nest with each other when stacked up on top of one another (e.g., coiled) in a retracted or opened state of the door. The links may include both a rigid material and a relatively softer material. The softer material can be applied to a link contact zone such that when a first link engages a second link, the sound pressure produced by the impact engagement is at least partially absorbed and reduced.

In some embodiments, the links include a rib and a groove. The rib is dimensioned to nest within the groove of adjacent links as the links are rolled or coiled into a spiral formation, such as when the door panel of the roll-up door is opening or is in an opened position. In some embodiments, the groove includes a secondary channel disposed within the groove. The secondary channel is configured to receive a flexible insert comprising a relatively softer, resilient material. In some embodiments, the flexible insert is configured as a urethane strip. The urethane strip is configured to provide sound abatement when a rib from a first link nests with a groove of a second link within which at least a portion of the urethane strip is positioned. In other embodiments, the flexible insert may include additional or alternative polymers, such as rubber, for example.

In some embodiments, a link for use in a roll-up door includes a retention bore and a threaded bore on a first end of the link, and a pivot bore on a second end of the link. The threaded bore includes threads on an inner surface that are configured to engage a threaded pin (e.g., a shoulder bolt). The threaded pin bolt can extend through each of the retention bore and the threaded bore of one link and through a pivot bore of another link, such that the pivot bore is positioned between the retention bore and the threaded bore, thereby coupling the links together. In one embodiment, the pivot bore may include a plastic compatible lubricant configured to lower friction between an inner surface of the pivot bore and the threaded pin.

In further embodiments, the pivot bore may include a bearing disposed adjacent an inner surface of the pivot bore. In some embodiments, the bearing may be a sleeve bearing configured to engage the inner surface of the pivot bore and dimensioned to slideably receive the threaded pin. In some embodiments, the sleeve bearing is configured to reduce friction and can be impregnated with a compatible lubricant. In some embodiments, the sleeve bearing is configured to be more wear resistant as compared to the pivot bore.

### BRIEF DESCRIPTION OF THE DRAWINGS

The following detailed description is to be read with reference to the figures, in which like elements in different figures have like reference numerals. The figures, which are not necessarily to scale, depict select embodiments and are not intended to limit the scope of embodiments of the invention. Given the benefit of this disclosure, skilled artisans will recognize the examples provided herein have many useful alternatives that fall within the scope of the invention.

FIG. 1 is a top left isometric view of a roll-up door assembly including a header and a support frame according to one embodiment of the invention.

FIG. 2 is a top left isometric view of the support frame of FIG. 1.

FIG. 3 is a bottom left isometric view of the support frame of FIG. 1.

FIG. 4 is an exploded top left isometric view of the header and the support frame of FIG. 1.

FIG. 5 is a front perspective view of the roll-up door assembly of FIG. 1 secured to a face frame that is installed proximate to a doorway, and with a door panel in a closed position, according to one embodiment of the invention.

FIG. 6 is a detailed view of a reel assembly and a link assembly within the header of the roll-up door assembly of FIG. 5 circumscribed by arc 6-6, according to one embodiment of the invention.

FIG. 7 is a cross-sectional side view of the reel assembly and the link assembly formed in a spiral that corresponds to the door panel in an opened position, the cross section taken along line 7-7 of FIG. 1.

FIG. 8 is a top isometric view of a link of the link assembly of FIG. 7 according to one embodiment of the invention.

FIG. 9 is a bottom isometric view of the link of FIG. 8.

FIG. 10 is a side view of the link of FIG. 8.

FIG. 11 is a cross-sectional view of a first hinge structure of the link taken along line 11-11 of FIG. 10.

FIG. 12 is a cross-sectional view of a second hinge structure of the link taken along line 12-12 of FIG. 10.

FIG. 13 is a cross-sectional view of the link taken along line 13-13 of FIG. 10.

FIG. 14 is a cross-sectional view of a center of the link taken along line 14-14 of FIG. 10.

FIG. 15 is a side view of the link of FIG. 8 including the second hinge structure.

FIG. 16 is a cross-sectional view of the link taken along line 16-16 of FIG. 15.

FIG. 17 is an exploded isometric view of a link, a shoulder bolt, a sleeve bearing, and a flexible insert according to one embodiment of the invention.

FIG. 18 is a detailed view of the engagement of one link with another link of the link assembly of FIG. 6 circumscribed by arc 18-18.

FIG. 19 is a side view of the link assembly of FIG. 7 on a disk in an orientation that corresponds to a partially opened (or closed) position of the door panel, according to one embodiment of the invention.

FIG. 20 is a cross-sectional side view of the link assembly taken along line 20-20 of FIG. 19.

FIG. 21 is a detailed side view of a cross section of the link assembly partially coiled on the disk of FIG. 19.

FIG. 22 is a detailed cross-sectional perspective view of the link assembly taken along line 22-22 of FIG. 21.

FIG. 23 is a detailed side view of a link including a groove, a secondary channel, and a flexible insert according to one embodiment of the invention.

FIG. 24 is a detailed side view of the link of FIG. 23 including a rib of an adjacent link nested in the groove, according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having,” and variations thereof, herein is meant to encompass the items listed thereafter and equivalents thereof as well as additional items. Unless specified or limited otherwise, the terms “mounted,” “connected,” “supported,” and “coupled,” and variations thereof, are used broadly and encompass both direct and indirect mountings, connections, supports, and couplings. Further, “connected” and “coupled” are not restricted to physical or mechanical connections or couplings. Likewise, the phrases “at least one of A, B, and C,” “one or more of A, B, and C,” and the like, are meant to indicate A, or B, or C, or any combination of A, B, and/or C.

The following discussion is presented to enable a person skilled in the art to make and use embodiments of the invention. Given the benefit of this disclosure, various modifications to the illustrated embodiments will be readily apparent to those skilled in the art and the underlying principles herein can be applied to other embodiments and applications without departing from the invention. Thus, embodiments of the invention are not intended to be limited to embodiments shown, but are to be accorded the widest scope consistent with the principles and features disclosed herein.

As discussed above, a roll-up door assembly may include a header that houses various components including slats that make up the door panel. Prior to installation, the header may be coupled to a lift frame that is configured to provide a support structure, such that a lift truck may engage the roll-up door assembly at the lift frame without damaging the door panel or other components of the header. Following the installation of the header above a doorway, the lift frame is removed from the header and requires disposal from the jobsite, which is often costly and inconvenient. Furthermore, in use, conventional roll-up doors assemblies emit a relatively high sound pressure level when moved between a closed position and an opened position. In particular, plastic links that engage individual slats of the door panel coil onto one another and the impact of that coiling produces at least some of the undesirable noise. Additionally, when links are configured to form a lifting chain (e.g., when pivotally connected in an end-to-end fashion) the links are often subject to high loads and cyclical fatigue forces.

In some embodiments, a roll-up door assembly according to the invention can address many undesirable issues of traditional roll-up doors. For example, in some embodiments, the roll-up door assembly includes a removable lift frame that reduces the burdens related to the manufacture, disposal, and expense associated with traditional installation protocol. In particular, the removable lift frame may be primarily constructed of wood that is renewable and easily disposable and/or recyclable. Furthermore, in some embodiments, a roll-up door assembly includes a plurality of links disposed at the ends of each slat of a door panel; the links can include a flexible/resilient insert that can reduce or abate the noise associated with the coiling and nesting links during operation of the roll-up door. In some embodiments, the links can additionally or alternatively be configured to reduce friction between subsequent links, such as with selective application of a lubricant, a bearing, and/or some combination thereof.

The roll-up door assembly of the present disclosure includes a link assembly at each end of the header. In other forms, particular application requirements may result in use of a link assembly at only one end of the header. It is further understood that each link assembly includes a plurality of links, and throughout the disclosure, the links may be described in terms of a single link or multiple links. The description of a single link, unless otherwise specified, can be applied to all the links of the plurality of links in the link assembly. Additionally, some illustrations and descriptions of engagements of multiple links may use identical reference numbers though referring to separate links of the link assembly.

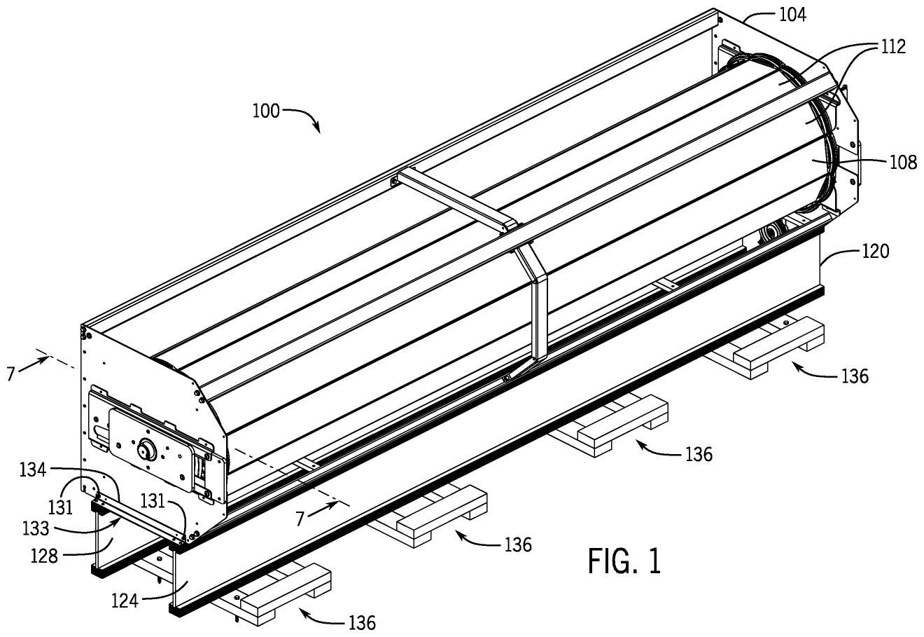

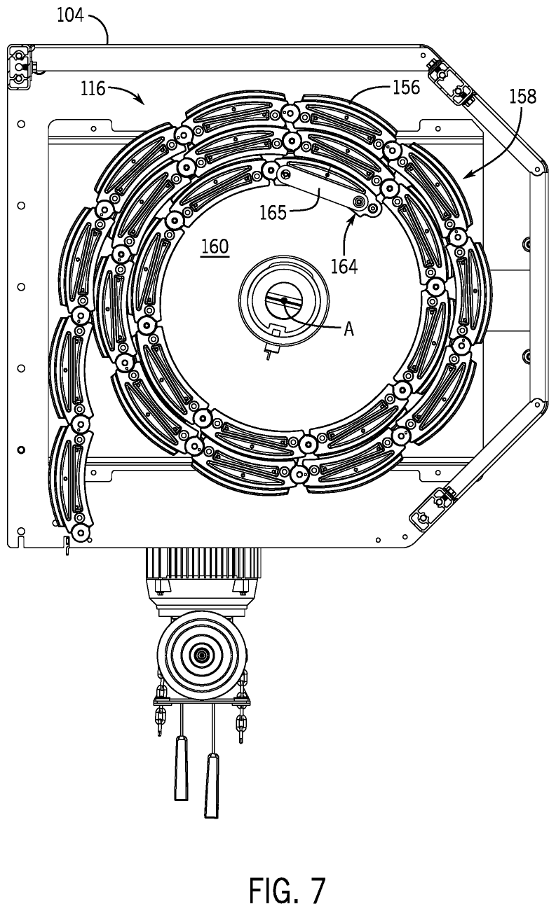

FIG. 1 illustrates a roll-up door assembly 100 that includes a header 104 according to one embodiment. In the illustrated embodiment and orientation, the header 104 houses the door panel 108, among other components of the roll-up door assembly 100. The door panel 108 includes a plurality of horizontally extending slats 112 that, as shown, are rolled onto a reel assembly 116 (see, for example, FIG. 7). The slats 112 rolled onto the reel assembly 116 generally correspond to the door panel 108 in an opened positioned. As shown, the roll-up door assembly 100 further includes a lift frame 120 that is configured to facilitate an installation process of the header 104, as will be described in detail below.

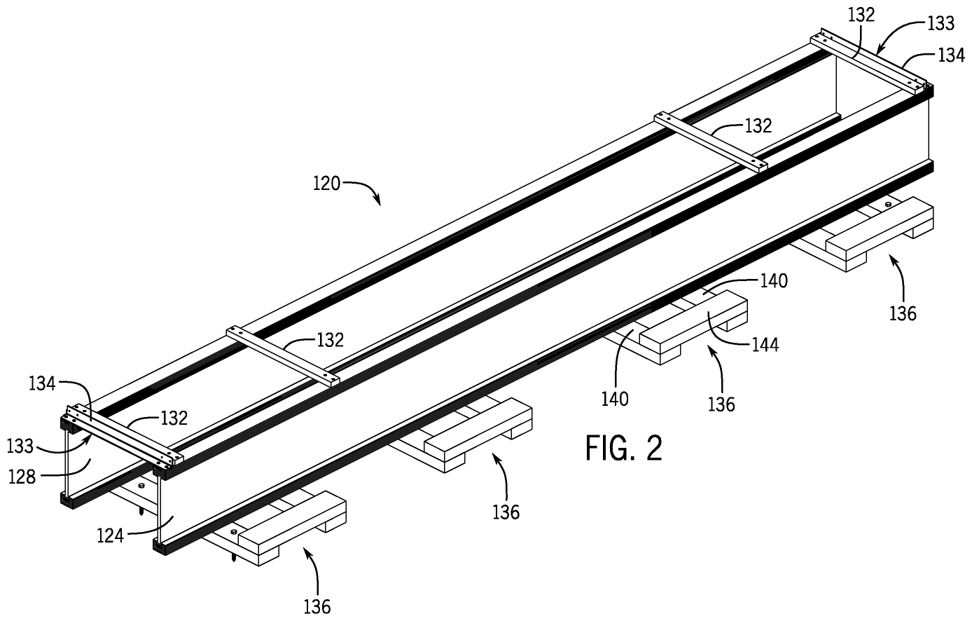

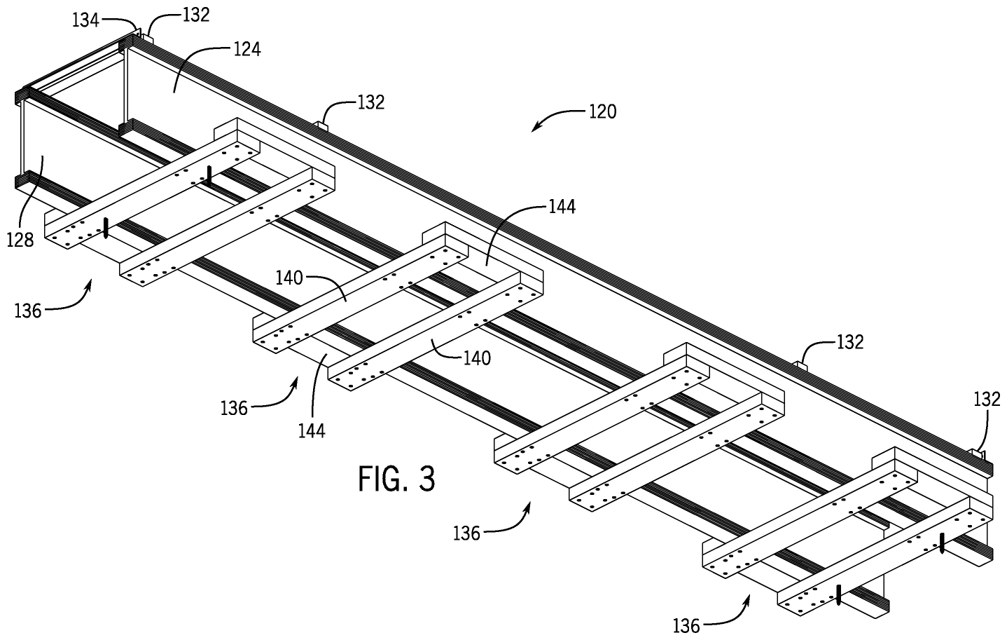

Referring now to FIGS. 2 and 3, the lift frame 120 is shown in isolation from the header 104. In one embodiment, the lift frame 120 generally comprises a pre-engineered wooden truss assembly. As illustrated, the truss assembly includes a first I-beam 124 that is substantially parallel to a second I-beam 128. The I-beams 124, 128 are connected by a plurality of crossbeams 132 and a plurality of support beam assemblies 136. As illustrated, the lift frame 120 is generally constructed from wood products, with the exception of fasteners and other hardware included therein. In some embodiments, the lift frame 120 may be constructed from one or more of pine, medium-density fiberboard, particleboard, and/or other types of natural and engineered wood product. For example, I-beams 124, 128 can be constructed from commercially available I-joist sections with laminated veneer or sawn lumber flanges, and plywood or oriented strand board (OSB) webs. In other embodiments, the lift frame 120 may be constructed from other recyclable or easily disposable materials, including plastics and composites.

In the illustrated embodiment, the plurality of crossbeams 132 is configured as four crossbeams 132 that are distributed across and secured to an upper flange of each of the first I-beam 124 and the second I-beam 128. The crossbeams 132 can be fastened (e.g., screwed) to the upper flange of the I-beams 124, 128. The crossbeams 132 provide anchor and/or support points between the header 104 and the lift frame 120. In one example, each of the end crossbeams 132 is adjacent to a metallic angle iron 133 that is also secured to the upper flange of each of the I-beams 124, 128. The angle irons 133 each define a vertical flange 134 that is configured to engage and selectively couple to the header 104. In other forms, straps, bands, and the like can be incorporated to temporarily secure the header 104 to the lift frame 120. Additionally, the plurality of support beam assemblies 136 are configured as four support beam assemblies 136 spaced across and secured to a lower flange of each of the first I-beam 124 and the second I-beam 128, opposite to the upper flange. As shown in FIG. 3, each of the support beam assemblies 136 include two support members 140 that extend in a direction perpendicular to each of the first I-beam 124 and the second I-beam 128, and cross supports 144 that connect the support members 140 proximate respective ends of the support members 140. The support beam assemblies 136 provide an engagement interface for use during the assembly process. For example, forks of a lift truck can engage and support the lift frame 120 by inserting the forks between pairs of support members 140 (e.g., the support members 140 of the two inner most or two outermost beam assemblies 136). The lift frame 120 (and header 104 when coupled to the lift frame 120) can be supported on the forks that engage the lower flange of the I-beams 124, 128 and portions of the cross supports 144. In one embodiment, the cross supports 144 of the beam assemblies 136 engage the forks of a lift truck to further stabilize the lift frame 120 and header 104 assembly (e.g., to inhibit undesired movement and enhance stability). The various components of the lift frame 120, including the crossbeams 132, the angle iron 133, the support members 140, and the cross supports 144 can be secured as shown with fasteners, such as screws, nails, adhesives, and the like.

In general, the lift frame 120 provides a support structure for a lift truck or other installation aid to engage without undesirably contacting and/or damaging the slats 112 of the door panel 108, or other components of the header 104. While an example of a truss structure is illustrated in FIGS. 2 and 3, other truss structures and variations will be appreciated by one of ordinary skill when given the benefit of this disclosure. For example, a number of configurations of support beams connected by crossbeams can provide a support structure capable of engaging a forklift to lift the header 104 without damaging the slats 112 of the door panel 108 or any other components of the header 104. Additionally, the sizing and scale of the lift frame 120 can be adapted to accommodate particular application requirements. For instance, a larger header 104 may define a longer span that may require additional beam assemblies 136 spaced along the I-beams 124, 128 or require use of additional I-beams. In one example embodiment, beam assemblies 136 can be configured and sized to accept industry standard fork tangs, and can be relatively positioned on spaced centers that correspond to typical or available fork truck spans.

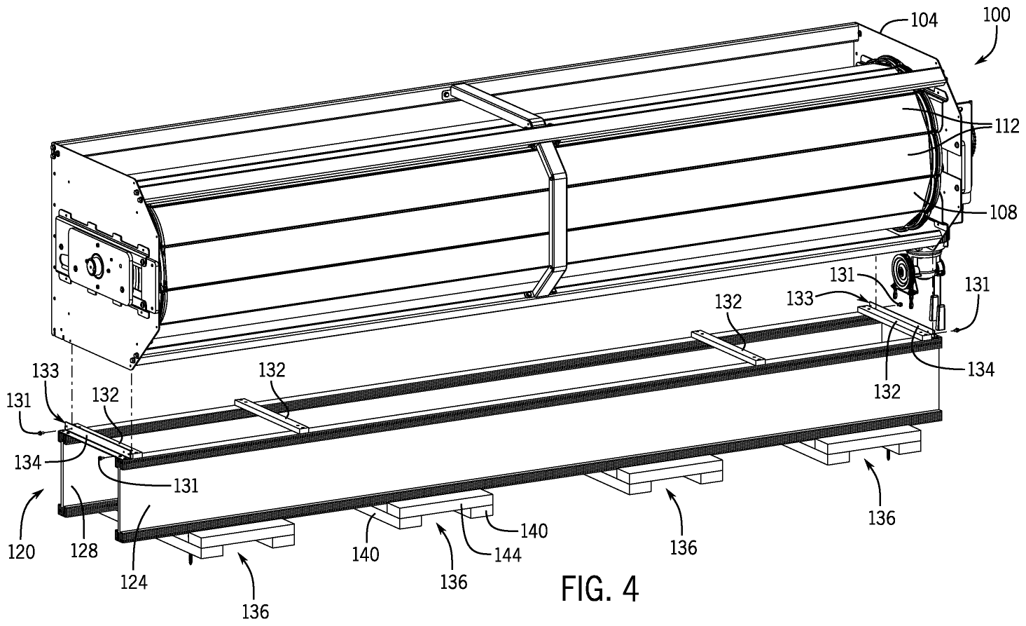

Referring now to FIG. 4, the lift frame 120 is configured to be selectively removed from the header 104. Prior to an installation of the header 104 above a doorway, the lift frame 120 may be coupled to the header 104. For example, a manufacturer may ship the roll-up door assembly 100 to a customer or installer with the lift frame 120 coupled to header 104. During the installation process, a lift truck, for instance, may be used to engage the roll-up door assembly 100 at the lift frame 120 and lift the header 104 to a desired installation height and position. The header 104 may then be secured at the desired installation height above the doorway. Once the header 104 is secured, the lift frame 120 may be decoupled from the header 104, for example via fasteners 131 that secure each of the vertical flanges 134 of the angle iron 133 to the header 104, and discarded. Additional fasteners, straps, bands, restraints, and the like may be used to releasably secure the header 104 to the lifting frame 120.

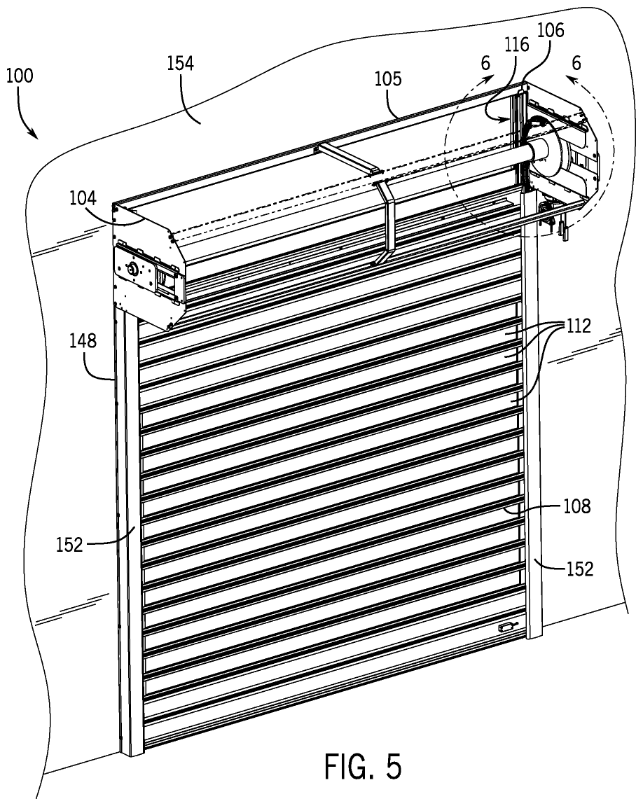

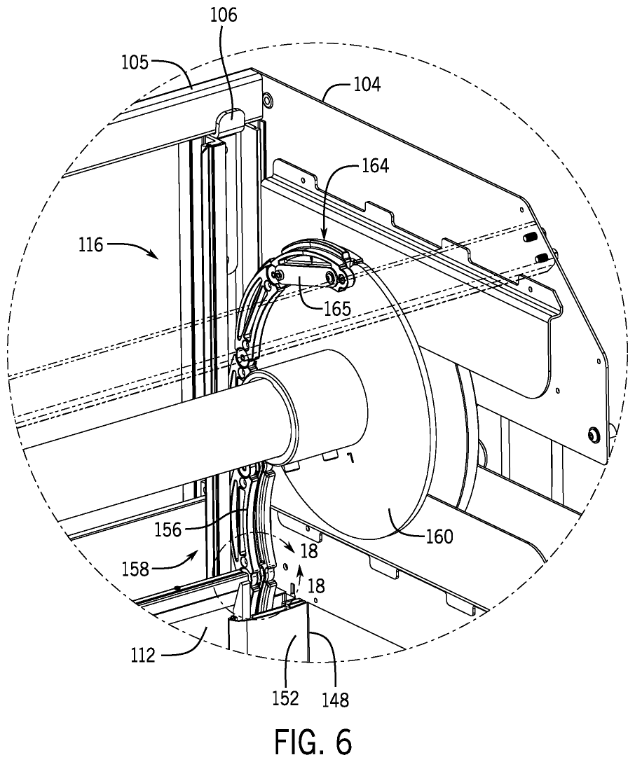

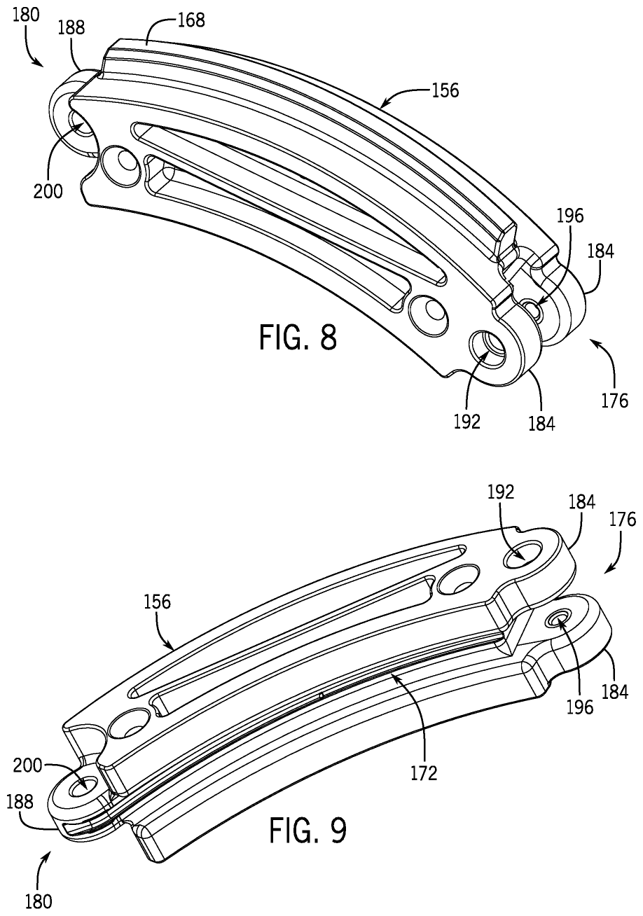

Turning to FIG. 5, the lift frame 120 has been removed, and the header 104 is shown installed and secured at a desired location above a doorway. In particular, the header 104 is installed and secured to a face frame 148 that includes side rails 152 that extend along the sides of the doorway and are coupled to a wall 154. In one embodiment, a spreader bar 105 of the header 104 is engaged with hanger brackets 106 that are coupled to and extend proximate upper ends of the face frame 152 (see, for example, FIG. 6). The side rails 152 generally provide side guides for the door panel 108. FIG. 5 illustrates the roll-up door assembly 100 in a closed position. In particular, the slats 112 of the door panel 108 are uncoiled from the reel assembly 116. The door panel 108 further includes a plurality of links 156 (see, for examples, FIGS. 8 and 9) that are included as part of a link assembly 158. The links 156 are coupled to opposing ends of each slat 112. As such, first and second link assemblies 158 are disposed on each side of the door panel 108. As illustrated in FIG. 5, the links assemblies 158 are illustrated as being at least partially enclosed within the side rails 152, and therefore not fully visible when the door panel 108 is in the closed position.

With additional reference to FIG. 6, the reel assembly 116, which is housed within the header 104, includes a disk 160. As shown, an end link 164 of the link assembly 158 is secured (e.g., bolted) to the disk 160, thereby providing an attachment point for the entire door panel 108 to the reel assembly 116. In some embodiments, several subsequent links 156 are secured to the end link 164 without being engaged to slats 112. In some embodiments, there may be between 1 and 5 subsequent links 156 between the end link 164 and links 156 that are engaged with slats 112. In general, the end link 164 is substantially identical to the links 156, which will be described in greater detail below. In other embodiments, an end link may have additional or alternative components than the links 156. For example, an end link may include a reinforcing structure, such as a bracket 165, to provide additional support to the attachment point of the door panel 108 to the reel assembly 116. In other forms, an end link may comprise an adjustable link.

The reel assembly 116 further includes a guide system that maintains a tangent between the reel assembly 116 and a closure plane of the doorway at the point of entry and exit of the door panel 108 to and from the header 104. In particular, the guide system maintains an aligned entry and exit of the links 156 within the side rails 152 of the face frame 148. Additional details and example embodiments of the reel assembly 116 and other components of the roll-up door assembly 100, such as the engagement of the links 156 and the slats 112, for example, are described in U.S. Pat. No. 10,344,527 entitled “Roll-Up Door” that issued on Jul. 9, 2019, which is hereby incorporated by reference.

Referring now to FIG. 7, a side view of the reel assembly 116 and the door panel 108 in a coiled position is illustrated; the door panel 108 has not been engaged with the face frame 148 and side rails 152. As shown, the links 156 of the link assembly 158 form a spiral on the outer perimeter of the disk 160. The links 156 stack up or nest on top of one another when the door panel 108 is rolled up, thus inhibiting the slats 112 from contacting each other. While the links 156 formed in the spiral on the left side of the header 104 are shown, it should be understood that, in the example embodiment, a similar spiral of links 156 is formed at the right side of the header 104, with the slats 112 generally extending between the links 156. In other forms in which the application-specific requirements permit, the link assembly may be positioned only along one side of a header. Furthermore, each link 156 includes features that allow nesting between the links 156 such that the spiral of links 156 remains generally planar and aligned when the door panel 108 moves between the opened and the closed positions. Such nesting features will be described in detail below.

As shown in FIGS. 8 and 9, the nesting features of each link 156 includes a rib 168 and a groove 172. The groove 172 of one link 156 provides a guide for the rib 168 of another link as the links 156 of the link assembly 158 stack on one another, which permits the links 156 to nest with one another. In other words, the groove 172 is dimensioned to receive the rib 168, or a portion of the rib 168 depending on the particular overlap between the links 156 as each coils about the disk 160. In the example embodiment, the arcuate rib 168 is located along an outer (relative to the disk 160) portion and the arcuate groove 172 is located along an inner (relative to the disk 160) portion. The example rib 168 and groove 172 have a similar radius of curvature as defined by a common pivot point, such as the rotational axis A of the disk 160 (illustrated in FIG. 7). In some embodiments, the radius of curvature of the rib 168 and groove 172 are adapted to accommodate the curvature of the disk 160.

Each link 156 further includes a first end 176 and a second end 180. Each of the first end 176 and the second end 180 include a first hinge structure 184 and a second hinge structure 188, respectively. In general, the first hinge structure 184 of one link 156 can be pivotally connected with a second hinge structure 188 of another, adjacent link 156 in the link assembly 158 in an end-to-end fashion. Referring again to FIG. 6, the end link 164 may include a first end that that is substantially similar to the first end 176 of the link 156 and a second end that is substantially similar to the second end 180 of the link 156, such that the first end 176 of one link 156 is configured to hingedly connect with the second end of the end link 164.

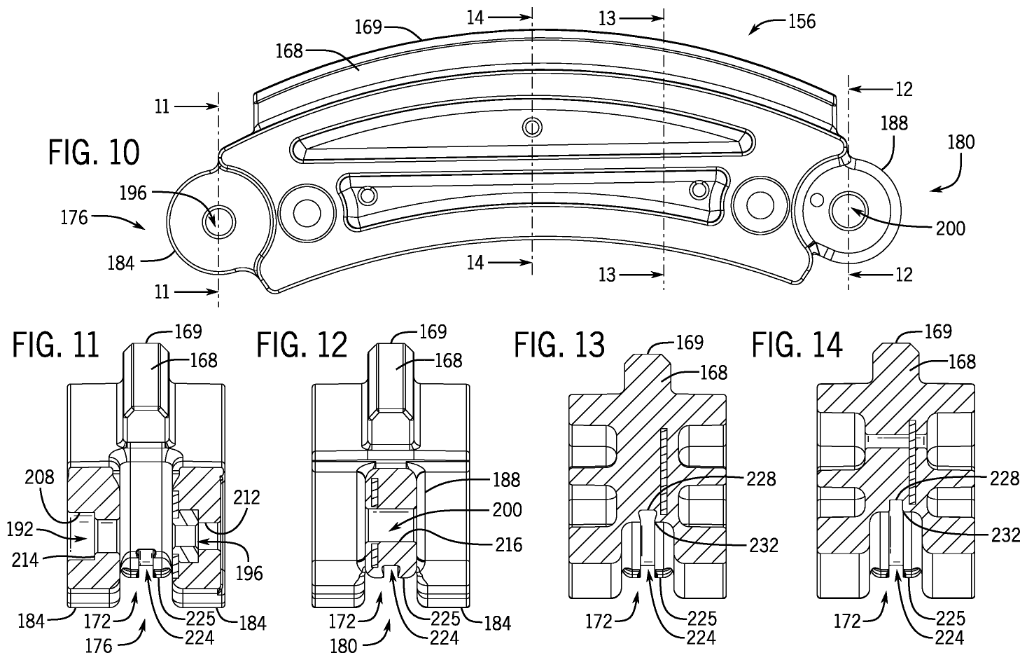

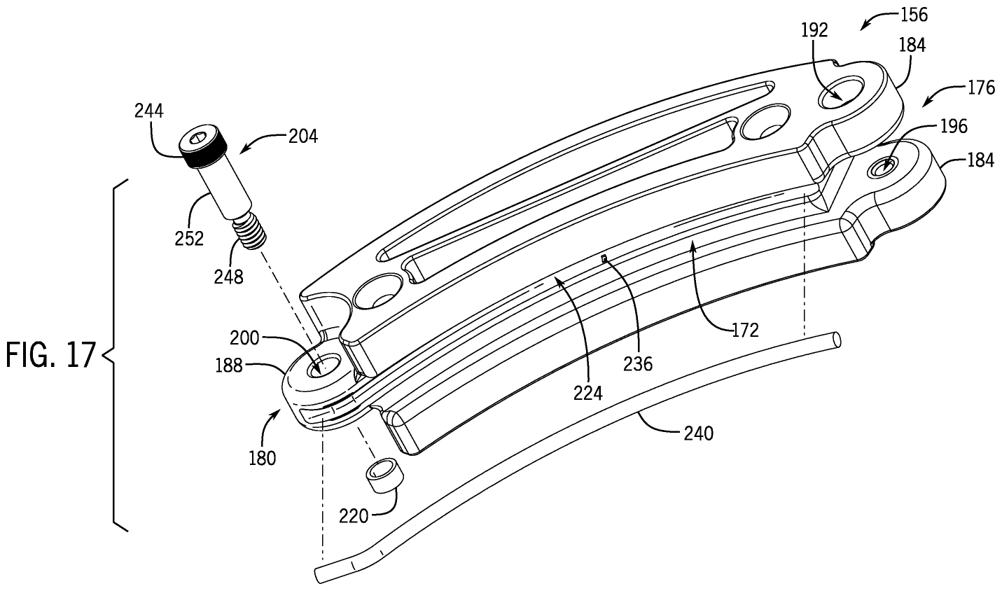

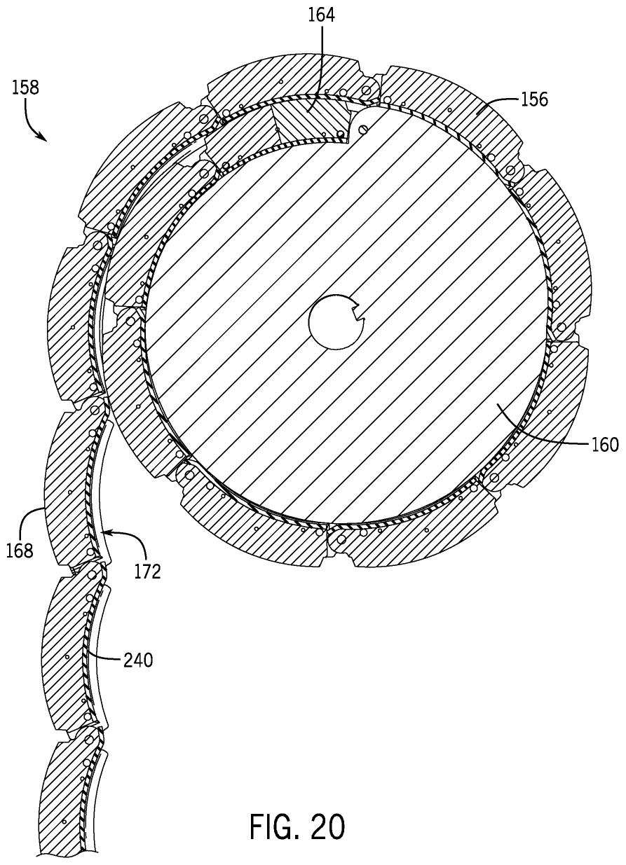

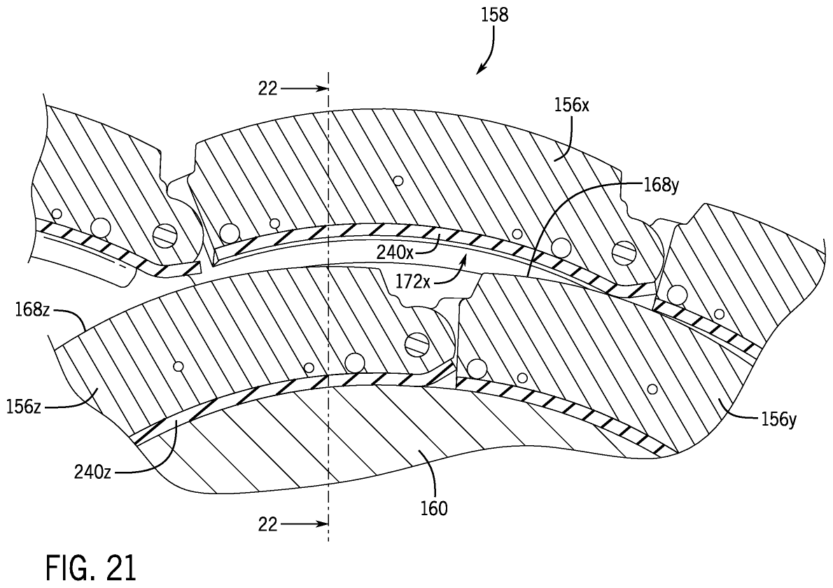

As illustrated, the first hinge structure 184 includes a retention bore 192 and a threaded bore 196 (e.g., such as provided via a threaded insert). Additionally, the second hinge structure 188 includes a pivot bore 200. Each of the retention bore 192, the threaded bore 196, and the pivot bore 200 are dimensioned to receive a hinge member, such as a threaded pin in the form of a shoulder bolt 204 (see, for example, FIG. 17). The shoulder bolt 204 is configured to hingedly connect the first hinge structure 184 of one link 156 with the second hinge structure 188 of another link 156 in the link assembly 158. In other embodiments, the first hinge structure 184 of one link 156 may be hingedly connected to the second hinge structure 188 of another link 156 via pin, rivet, bolt, and the like. In still other forms, the links may define other hinge structures, such as interdigitating fingers or laterally offset tabs. As noted above, the example end link 164 may be similar to links 156, with the first hinge structure 184 provided at both ends (e.g., the structure of the example end link 164 can generally be described as the link 156 mirrored across a transverse plane bisecting the link 156, such as along section 14-14 of FIG. 10, to duplicate the first hinge structure 184 at both ends of the end link 164). Having the first hinge structure 184 at both ends of the end link 164 can be beneficial by aiding assembly via enhanced access to inserting and engaging the shoulder bolts 204 from an exterior side of the link assembly 158, by providing a structure to couple the end link 164 to the disk 160 (shown, for instance, in FIG. 20), and by allowing a link 156 with a universal design to be utilized on both sides of the door panel 108.

Referring now to FIGS. 10-14, additional views of the example link 156 are illustrated. In particular, FIGS. 11-14 show various cross sections of the link 156 of FIG. 10. As illustrated in FIG. 11, for example, an inner surface 208 of the retention bore 192 and an inner surface 212 of the threaded bore 196 are shown. As illustrated, the inner surface 208 of the retention bore 192 includes two discrete bore diameters. As such, the diameter of the retention bore 192 on the lateral side is greater than the diameter of the retention bore 192 on the medial side, thereby providing a counter bore surface 214 within the retention bore 192. Furthermore, the inner surface 212 of the threaded bore 196 includes threads that are configured to threadably engage the shoulder bolt 204.

FIG. 12 illustrates an inner surface 216 of the pivot bore 200. The inner surface 216 of the pivot bore 200 is configured as a smooth, continuous surface that facilitates rotation on the shoulder bolt 204 to reduce friction. In some embodiments, the inner surface 216 of the pivot bore 200 can include a lubricant to further minimize friction between the shoulder bolt 204 and the pivot bore 200. In other embodiments, the inner surface 216 of the pivot bore 200 may include a bushing, such as a sleeve bearing 220 (see, for example, FIG. 17), which similarly reduces friction between the shoulder bolt 204 and the inner surface 216 of the pivot bore 200.

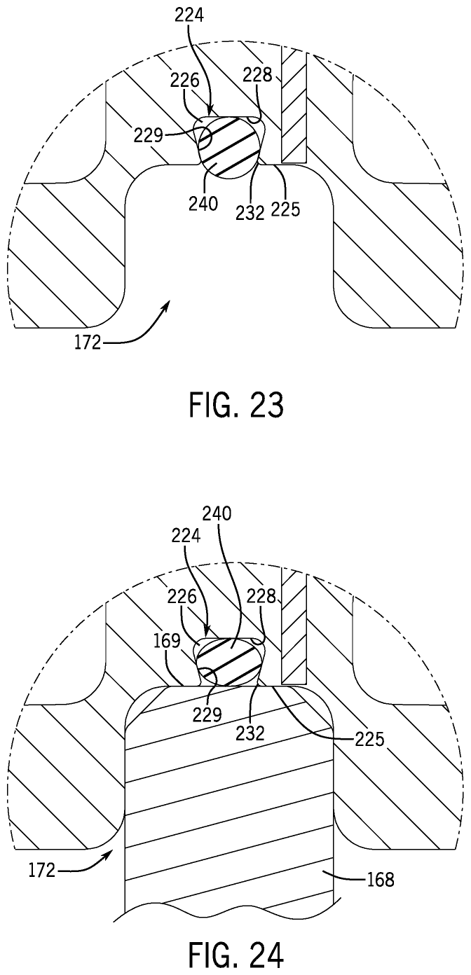

Each of FIGS. 11-14 additionally illustrate a secondary channel 224 formed within the groove 172 that extends along the link 156 between the first end 176 and the second end 180, and partially about the second hinge structure 188. The secondary channel 224 is recessed from a groove interface surface 225 defined within the groove 172 at which mating rib interface surfaces 169 of ribs 168 of adjacent links 156 are configured to engage when coiled. As shown in FIG. 13, the secondary channel 224 generally has a tapered profile such that a width at a base 228 of the secondary channel 224 is greater than a width of an opening 232 of the secondary channel 224. As described below in detail, an insert 240 is configured to interact with the secondary channel 224. In one embodiment, the width of the secondary channel 224 at the opening adjacent to the groove interface surface 225 is configured to establish an interference fit with the cylindrical insert 240 as it is passed into the secondary channel 224, such that the circular cross section of the example insert 240 is deformed from a natural geometry to pass into the secondary channel 22, whereat it is seated as shown in FIG. 23. A depth of the secondary channel 224 can be configured to allow a portion of the insert 240 to extend out from the secondary channel 224 and past the groove interface surface 225 when the insert 240 is not engaged with a rib 168 nested in the groove 172. As described below in more detail, the depth (and overall geometry) of the secondary channel 224 and the insert 240 are cooperatively configured to allow the insert 240 to fully deform into the secondary channel 224 when engaged with a rib interface surface 169 of a rib 168, such that the rib 168 ultimately engages and abuts the groove interface surface 225 when coiled. In further embodiments, other profiles of a secondary channel are contemplated. For example, a width at a base of the secondary channel 224 may be equal or less than a width at an opening of a channel. In further embodiments, a secondary channel may have any number of regular or irregular-shaped cross sections and/or features that aid insertion, retention, and/or operation of a noise abatement feature described below in more detail.

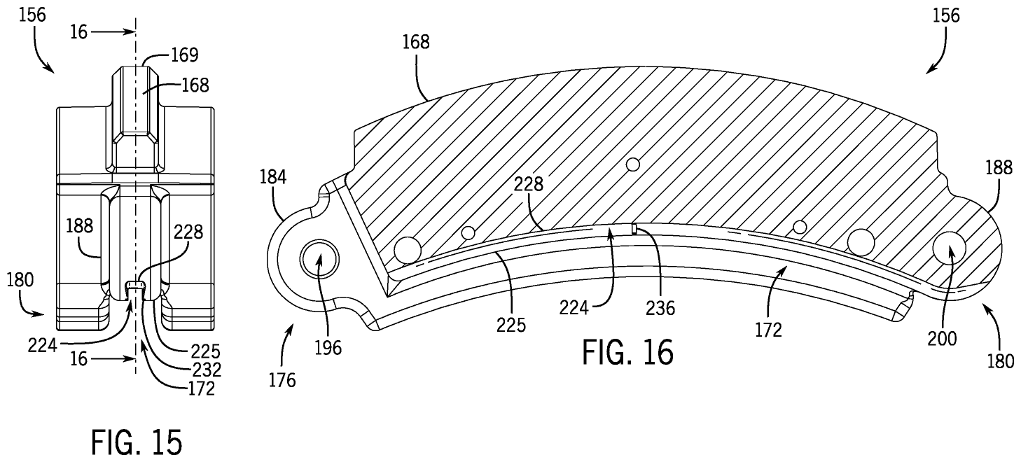

In the illustrated embodiment, the secondary channel 224 further includes slanted projections 236 (see, for example, FIG. 16). The example projections 236 are centered between the first end 176 and the second end 180 of the link 156 and extend inwardly from lateral sides of the secondary channel 224. As shown in FIG. 14, the projections 236 create a generally square-shaped profile within the secondary channel 224, such that the width of the base 228 of the secondary channel 224 appears to have a substantially equal width of the opening 232 when a cross section is taken through the projections 236. In use, the projections 236 aid and promote a generally longitudinal expansion of the insert 240 (i.e., generally along the length of the secondary channel 224) as the insert 240 is compressed at the interface by one or more adjacent ribs 168 nesting into the groove 172 and impacting the insert 240. In one form, the projections 236 inhibit the insert 240 from undesirable linear migration along the secondary channel 224. The example construction of the projections 236 further inhibit the insert 240 from unseating with the secondary channel 224 during the cyclical engagement with ribs 168 during operation, while also inhibiting increased wear that may occur if the insert 240 is more fully constrained within the secondary channel 224.

FIGS. 15 and 16 further illustrate the secondary channel 224 within the groove 172. In particular, the secondary channel 224 is illustrated as extending partially through and about the second hinge structure 188. As viewed in the longitudinal cross section, the secondary channel 224 comes to a tapered end at the second hinge structure 188, which is centered laterally on the link 156. Alternatively, the secondary channel 224 ends within the groove 172 before the first hinge structure 184, which includes dual structures that are adjacent to the lateral sides of the link 156.

Referring now to FIG. 17, an exploded view of the link 156, the shoulder bolt 204, the sleeve bearing 220, and a flexible insert 240 according to one embodiment of the invention is illustrated. The shoulder bolt 204 includes a head 244, a threaded portion 248, and a smooth cylindrical portion 252 that extends there between. In one embodiment, and again with reference to FIG. 11, the head 244 is dimensioned to engage the counter bore surface 214 of the retention bore 192 and the threaded portion 248 is configured to threadably engage the threads of the threaded bore 196. In addition, the smooth portion 252 of the shoulder bolt 204 is dimensioned to be received by the retention bore 192 of one link 156 and the pivot bore 200 of another link 156 in the link assembly 158 to create a hinged connection between the two adjacent links 156. In general, each pivot bore 200 of one link 156 that is coupled to another link 156 in the link assembly 158 rotates on the smooth cylindrical portion 252 of each shoulder bolt 204 that is extended there through.

As introduced above, in some embodiments, the sleeve bearing 220 can be inserted between the pivot bore 200 and the smooth cylindrical portion 252 of the shoulder bolt 204. The bearing 220 can be implemented to decrease friction at and overall wear of the second hinge structure 188. In additional or in alternative embodiments, lubrication may be used in combination with the sleeve bearing 220. In some embodiments, the lubrication may be applied to one or both of the shoulder bolt 204 and the pivot bore 200 before the links 156 are assembled. In other embodiments, lubrication may be applied to the pivot bore 200 after the shoulder bolt 204 is received therein and as-needed throughout the life of the roll-up door assembly 100. Further still, the bearing 220 can take on a variety of form factors (e.g., split ring, flange, etc.) and can be impregnated with a lubricant. The lubrication, whether used in a bearing arrangement or not, is selected to accommodate application specific material (e.g., plastic compatible) and duty cycle requirements. In some forms, the lubrication can include non-migrating, high pressure lubrication that is compatible with the application-specific plastic, such as TEFLON impregnated silicone lubricating grease.

As further illustrated in FIG. 17, the resilient, flexible insert 240 is configured as a noise abatement/reduction strip. In the example embodiment, the insert 240 is dimensioned to be received by the secondary channel 224 and has a length substantially similar to that of the length of the secondary channel 224 into which it is secured. In the illustrated embodiment, each link 156 within the link assembly 158 includes a corresponding flexible insert 240. In other embodiments, the flexible insert 240 may be longer than the secondary channel 224 of one link 156 such that it is received within the secondary channel 224 of multiple (or all) links 156 in the link assembly 158. In other embodiments, the flexible insert 240 may be configured as multiple inserts dispersed along the secondary channel 224 of a single link 156. For example, the multiple inserts may be configured as soft/resilient beads spaced across the length of the secondary channel 224. In other embodiments, a soft/compliant coating may be applied to the groove 172 of one or more links 156 to similarly establish a noise abatement interface between links 156 of the link assembly 158. In other embodiments, a coating or a strip may be applied to or engaged with the ribs 168 of one or more links 156, instead of or in addition to the flexible insert 240 located proximate the groove 172. In one example embodiment, the insert 240 may have a hardness of Shore A 89. In other embodiments, the material properties and form factor of the insert 240 can be selected based on application-specific factors, such as the dimensions and weight of the accompanying door, the noise/sound abatement requirements, the forces imparted during operation of the link assemblies 158, and the associated geometry of the secondary channel 224 into which the insert 240 is to flex or deform into when engaged with adjacent links 156 during operation.

The flexible insert 240, as illustrated, generally has a circular cross section, but can be slightly deformed from a natural form factor when received within the secondary channel 224. In particular, the flexible insert may be deformed when pressed through the opening 232 of the secondary channel 224, which, as described above, is generally narrower than the base 228 of the secondary channel 224. The contours of the secondary channel 224, such as the narrower opening 232, can be configured to restrain the insert 240 and inhibit undesired removal of the insert 240 during operation. In other example embodiments, an adhesive may be used to secure the insert 240 in a desired location/position, such as by use of adhesive at a single discrete, limited segment/point along the insert 240, and not the entire length of the insert 240. In some embodiments, the flexible insert 240 is generally unbiased and not pre-formed prior to being inserted into the secondary channel 224. As such, the flexible insert 240 can take at least a portion of the shape and contour of the secondary channel 224, as illustrated by the slight curvature and contouring of the flexible insert 240 shown in FIG. 17. In the illustrated embodiment, the flexible insert 240 comprises a urethane strip; however, other materials are contemplated. For example, the flexible insert may include additional or alternative polymers, such as rubber. In still other embodiments, the insert 240 may be comprised of materials such as silicone, high-density foam, and/or any energy absorbing elastomer (EAE).

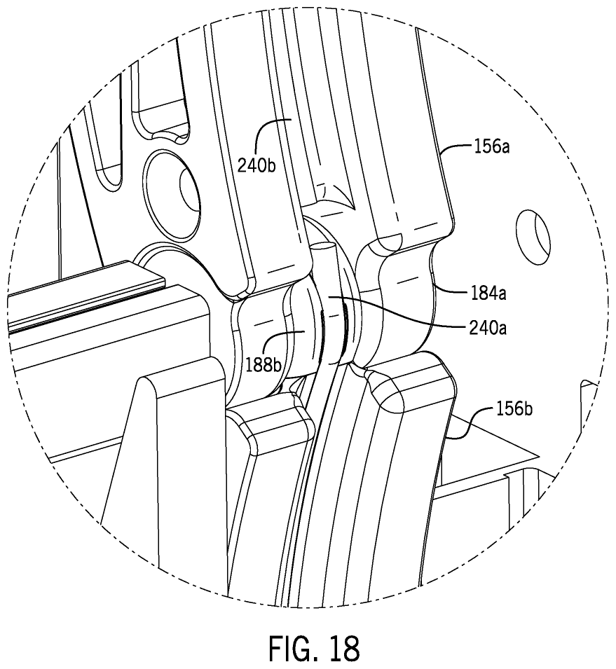

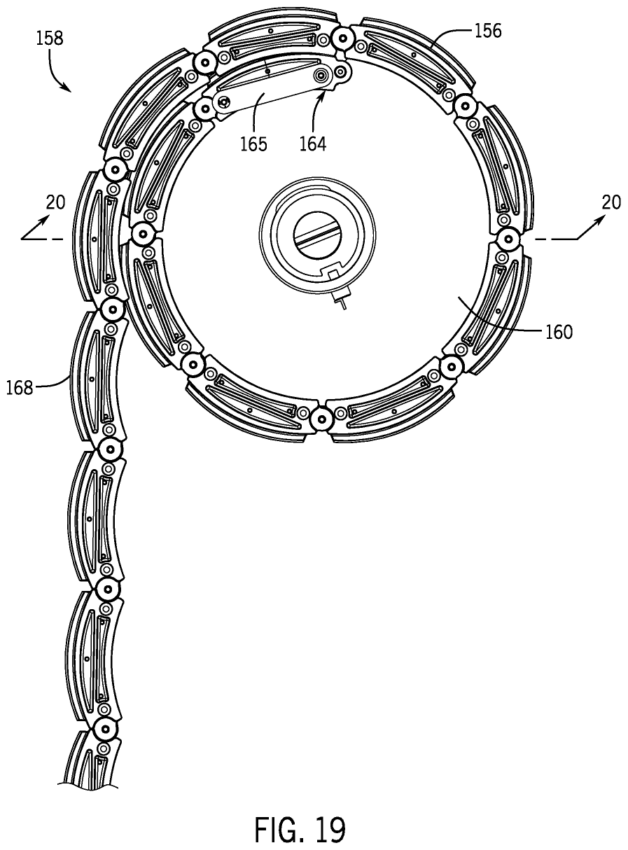

Referring now to FIG. 18, the engagement of an upper link 156a with a lower link 156b is illustrated according to one embodiment of the invention. As illustrated, each link 156a, 156b includes respective flexible inserts 240a, 240b. The flexible inserts 240a, 240b are dimensioned such that the flexible insert 240a of upper link 156a does not interfere with the flexible insert 240b of the lower link 156b when the first hinge structure 184a of the upper link 156a is engaged with the second hinge structure 188b of the lower link 156b. Additionally, as shown, the flexible insert 240a extends partially along the second hinge structure 188b thereby providing coverage along both links 156a, 156b on the surface that may engage the ribs 168 of additional links 156 of the link assembly 158 when in the coiled arrangement shown, for example, in FIGS. 19 and 20. In one embodiment, the flexible inserts 240 are configured to be discrete segments primarily associated with a single respective link 156. This arrangement accommodates the pivotal, hinge movement of adjacent links 156. In other embodiments, the resilient insert can be adapted to span multiple or all of the links 156 in a link assembly 158. In this form, the pivoting of the adjacent links 156 can be accommodated with, for instance, providing additional length to some or all of the inserts 156 and/or providing inserts 156 with material properties (e.g., elasticity) sufficient to accommodate the range of movement observed by the link assembly 158 in use.

Further illustrated in FIGS. 19 and 20, the link assembly 158 is shown in a position that corresponds to a partially opened (or partially closed) state of the door panel 108. As discussed above, the links 156 of the link assembly 158 are configured to nest with each other when the door panel 108 is moved between the opened and closed positions. Furthermore, the rib 168 of each link 156 is dimensioned to contact the flexible insert 240 within the secondary channel 224 of one or more of the other links 156 within the link assembly 158. During the opening of the door panel 108, the ribs 168 impact the grooves 172 of the links 156 in the link assembly 158. The resilient, flexible inserts 240 absorb and diminish at least a portion of that impact, thereby reducing the plastic impact noise that otherwise creates a relatively high sound pressure level during operation of the door panel 108. Additionally, the end link 164, similar to the links 156, includes a flexible insert comparable to the flexible inserts 240 of the links 156, but for instance the flexible insert of the end link 164 may be relatively shorter to accommodate coupling to the disc 160. In other embodiments, the groove 172 of the end link 164 may contact the disk 160 directly.

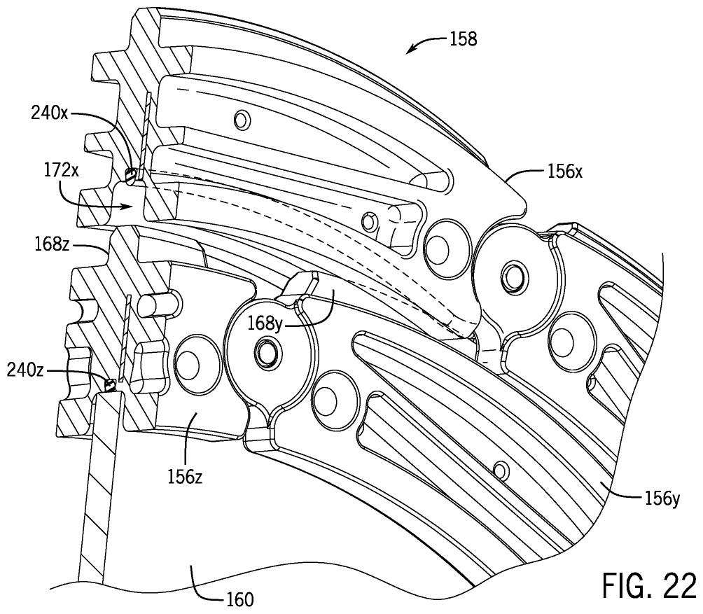

One example of ribs 168 engaging grooves 172 is shown in FIG. 21, with additional reference to FIGS. 22 and 23. In particular, as illustrated, links 156x, 156y, 156z of the link assembly 158 are in a process of forming (or deforming) the spiral about the disc 160. In other words, the illustrated configuration corresponds to the door panel 108 in a partially opened (or closed) position. As shown, groove 172x of the link 156x is partially engaged with the rib 168y of the link 156y and near to engagement with the rib 168z of link 156z. While a radius of curvature associated with each link 156 is constant, the radius of curvature of the spiral formed by the link assembly 158 is variable as the links 156 coil. As a result, the links 156 in the link assembly 158 contact other links 156 at various locations along their respective ribs 168 and grooves 172, and that the configuration illustrated in FIGS. 21 and 22 is shown as an example. The interface between stacked, nested links 156 can vary between substantially fully overlapping to minimally overlapping at the ends of the interfacing links 156.

As shown in FIG. 22 in particular, the rib 168y is at least partially received by the groove 172x and is engaging the flexible insert 240x of the link 156x. In general, each flexible insert 240 is partially received within each secondary channel 224 such that a portion of the flexible insert 240 extends into the groove 172, as illustrated in FIG. 23. This extension of the flexible insert 240 into the groove 172 is the interface at which the rib 168 of another link 156 in the link assembly 158 makes contact. Again, this interface thereby inhibits and/or reduces the impact noise of the links 156 of the link assembly 158, especially as the door panel 108 is moved to the opened position and the link assembly 158 forms the spiral. Similarly, the extension of the flexible insert 240 into the groove 172 allows the links 156 that immediately follow the end link 164 to contact the disk 160, such as the flexible insert 240z shown in FIGS. 21 and 22, thereby reducing the impact noise of the links 156 of the link assembly 158 as each interfaces with the disk 160.

The example embodiment of the sound abatement concept is further described with additional reference to FIGS. 22 and 23. As noted above, the example insert 240 and the example secondary channel 224 can be adapted to cooperate and interact, such that the insert 240 can be securely seated in the secondary channel 224, positioned to functionally engage with a mating rib 168 nested within the groove 172, and dimensioned to fully deform into the secondary channel 224. For instance, the form factor of the example secondary channel 224 includes an opening 232 that is sized relative to the diameter of the example insert 240, such that an interference fit is established between the diameter of the insert 240 and the width of the opening 232. In one example, the diameter of the insert is nominally 0.160 inches and the width of the opening 232 is less than that diameter of the insert 240, but sufficient to allow insertion of the insert 240 without damage to the insert 240 or requiring excessive force. The depth of the secondary channel 224 from the groove interface surface 225 can be sized and dimensioned to allow the insert 240 to seat into the secondary channel 224. The insert 240 can be seated in the secondary channel 224 a sufficient distance to allow the cross sectional center of the insert 240 to pass beyond the opening 232 and groove interface surface 225, such that sidewalls 229 of the secondary channel 224 inhibit unintentional removal of the insert 240 from the secondary channel 224. In one example embodiment, the sidewalls 229 and the insert 240 are adapted such that the sidewalls 229 are generally oriented tangential to the outer circumference of the circular insert 240 when the insert 240 is seated in the secondary channel 224 in an uncompressed state. The profile of the secondary channel 224 (e.g., as viewed in the cross section of FIG. 23) defines a cavity 226 that the insert 240 partially fills when in the non-engaged, un-deformed state (e.g., when a rib 168 is not nested into the groove 172). In the example embodiment, the form factor of the secondary channel 224 and of the insert 240 are cooperatively configured such that the cavity 226 is sufficient to accommodate the entirety of the insert 240 when the insert 240 is deformed and urged into the secondary channel 224 via engagement with the rib engagement surface 169 of a rib 168 that is nested in the groove 172. As a result, in one embodiment, the secondary channel 224 and the insert 240 are configured to permit direct engagement between the groove interface surface 225 and the rib interface surface 169 when the rib 168 is nested within the groove 172, thus allowing a compact coiling of links 156 in the link assembly 158. In some embodiments, the interacting and cooperating form factors of the secondary channel 224 and of the insert 240 establish a noise/sound abatement construction in that the rib interface surface 169 first engages the insert 240, and as the rib 168 further nests into the groove 172, at least a portion of the impact forces of the rib 168 are directed toward deforming the insert 240 into the cavity 226 of the secondary channel 224, thus reducing the impact force acting to engage the rib interface surface 169 directly against the groove interface surface 225.

Given the benefit of this disclosure, one of ordinary skill in the art will appreciate that alternative arrangements are available to provide a noise/sound abatement configuration (e.g., insert 240 and secondary channel 224) at the interfaces between multiple links. For instance, alternatively or additionally, the form factors (e.g., sizes, shapes, dimensions, relative positions, and the like) of the cooperating insert and channel structures may be altered while maintaining the desired abatement. In still other embodiments, the examples can include incorporation of an insert seated in a groove/secondary channel formed on the rib along the outer rib interface surface of the links, thus effectively swapping the functions of the rib and the groove/secondary channel.

Any of the embodiments described herein may be modified to include any of the structures or methodologies disclosed in connection with different embodiments. As noted previously, it will be appreciated by those skilled in the art that while the disclosure has been described above in connection with particular embodiments and examples, the disclosure is not necessarily so limited, and that numerous other embodiments, examples, uses, modifications, and departures from the embodiments, examples, and uses are intended to be encompassed by the accompanying claims. For example, the noise abatement features and concepts can be employed with other types of roll-up doors that include for form of link engagement. Various features and advantages of the invention are set forth in the following claims.

1. A roll-up door assembly comprising:
a plurality of links operatively coupled and configured to coil and uncoil during use, at least some of the plurality of links include at least one of a rib and a groove, wherein the ribs and the grooves are configured such that the rib can nest within the groove when the plurality of links are coiled;
a secondary channel in at least one of the groove and the rib of a first link of the at least some of the plurality of links; and
an insert seated within the secondary channel and configured to extend beyond the secondary channel to interface with the groove or the rib of a second link of the at least some of the plurality of links coiled to stack with the first link.

2. The roll-up door assembly of claim 1, wherein the secondary channel is formed in the groove of the first link.

3. The roll-up door assembly of claim 2, wherein:
the secondary channel defines a length along the first link; and
the insert is sized to extend the length of the secondary channel.

4. The roll-up door assembly of claim 2, wherein the secondary channel and the insert are configured such that the insert can be fully deformed into a cavity defined by the secondary channel when the insert is urged into the cavity by the rib of the second link.

5. The roll-up door assembly of claim 4, wherein the secondary channel and the insert are configured such that a rib interface surface of the rib of the second link directly engages with a groove interface surface when the insert is fully deformed into the cavity defined by the secondary channel.

6. The roll-up door assembly of claim 2, wherein the secondary channel and the insert are configured such that the rib of the second link initially engages the insert when the rib of the second link is nested with the groove of the first link.

7. The roll-up door assembly of claim 1, wherein the secondary channel defines opposing sidewalls that are oriented tangential to an outer surface of the insert.

8. The roll-up door assembly of claim 1, wherein:
the secondary channel comprises a plurality of secondary channels formed in the grooves of multiple successive links of the plurality of links; and
the insert comprises a continuous insert seated within the plurality of secondary channels of the multiple successive links.

9. The roll-up door assembly of claim 1, wherein the insert comprises multiple segmented inserts seated within the secondary channel.

10. The roll-up door assembly of claim 1, wherein the insert comprises at least one of a strip and a coating.

11. The roll-up door assembly of claim 1, wherein the insert defines a circular cross section transverse to a longitudinal axis of the insert.

12. The roll-up door assembly of claim 1, wherein the ribs and the grooves of the at least some of the plurality of links are arcuate.

13. A link capable of use with a roll-up door, the link comprising:
a rib;
a groove opposite to the rib;
a secondary channel in one of the rib and the groove; and
an insert seated in and extending from the secondary channel.

14. The link of claim 13, wherein the secondary channel is formed in the groove.

15. The link of claim 14, wherein:
the secondary channel defines a cavity;
the insert defines a volume; and
the cavity is sized to accommodate the volume of the insert.

16. The link of claim 13, wherein the secondary channel includes a projection configured to inhibit linear migration of the insert along the secondary channel.

17. The link of claim 13, wherein:
the link is arcuate; and
the groove defines a form factor that is the inverse of the rib.

18. The link of claim 13, the link further comprising:
a first hinge structure proximate a first end of the link; and
a second hinge structure proximate a second end of the link;
wherein the secondary channel extends from the first end to the second end and at least partially about the second hinge structure whereat the secondary channel terminates in a tapered end.

19. The link of claim 13, wherein:
the groove defines an interior surface;
the secondary channel is formed in the interior surface of the groove and defines a base with opposing sidewalls that extend from the base;
the opposing sidewalls are oriented tangential to an outer surface of the insert when the insert is its natural form within the secondary channel; and
the secondary channel and the insert are configured such that at least a portion of the insert extends beyond the interior surface of the groove when the insert is seated within the secondary channel.

20. A roll-up door assembly, comprising:
a plurality of links coupled end-to-end and configured to spiral during use;
a first link of the plurality of links defines a rib;
a second link of the plurality of links defines a groove sized to receive the rib;
a secondary channel formed in at least one of the rib and the groove; and
an insert seated in the secondary channel and extending at least partially out of the secondary channel.
